(19) United States
(12) Patent Application Publication
(10) Pub. No.: US 2004/0205366 A1
(43) Pub. Date: Oct. 14, 2004

(54) Method for avoiding data loss in a PDA

(76) Inventors: Hung-Chang Hung, Taipei City (TW); Yu-Pao Huang, Sangchong City (TW); Liang-Hsin Chien, Shuling City (TW); Chien-Wen Chen, Yonghe City (TW); Ming-Chih Hsieh, Taipei City (TW); Chi-Chung Yu, Yonghe City (TW)

Correspondence Address: RABIN & Berdo, PC, 1101 14TH STREET, NW, SUITE 500, WASHINGTON, DC, 20005, US

(21) Appl. No.: 10/812,082

(22) Filed: Mar. 30, 2004

(30) Foreign Application Priority Data
Apr. 9, 2003 (TW) 92108092

(51) Int. Cl. G06F 11/30

(52) U.S. Cl. 713/340

(57) ABSTRACT

A method for avoiding data loss in a PDA. The PDA has a RAM, a battery, a central processing unit (CPU), and a nonvolatile accessible memory. The nonvolatile accessible memory has a predetermined region, and the RAM stores user information including global operating system settings. User information is backed up into the predetermined region when remaining power of the battery is lower than a default value. Further, user information from the predetermined region is restored to the RAM when system power is recovered.

### BACKGROUND OF THE INVENTION

1. Field of the Invention

The present invention relates to PDA (personal digital assistant) technology, and more particularly, to a method for avoiding data loss in a PDA, as well as a PDA using the same.

2. Description of the Related Art

FIG. 1 is a block diagram of a conventional personal digital assistant (PDA). The PDA 100 includes a central processing unit (CPU) 10, a flash memory 12, a random access memory (RAM) 14, and peripheral components 16. The flash memory 12 stores preset data or programs, and the CPU 10 executes programs or processes data. Typically, the RAM 14 stores user information, such as file system, registry, global operating system settings and the like. For example, the RAM 14 can be a dynamic random access memory (DRAM) or a static random access memory (SRAM). In addition, the peripheral components 16 can include an LCD display, a keypad, an infrared transducer, and the like. However, data stored in RAM 14 may be lost when the PDA 100 loses power or power is low because the RAM 14 requires power to retain stored data. At this time, user information must be re-entered, causing inconvenience.

To avoid data loss, users can back up user information to another location outside the PDA 100, such as a computer. If user information in the RAM is lost, users have to download user information from the computer to recover. Therefore, this creates inconvenience.

### SUMMARY OF THE INVENTION

It is therefore an object of the present invention to retain user information stored in a PDA even if system power is lost.

In response to the above-mentioned object, the present invention provides a PDA capable of retaining user information stored therein when system power is lost.

In the PDA of the present invention, a nonvolatile accessible memory stores preset data and programs and has a predetermined region. A random access memory (RAM) stores user information, a battery powers the PDA, and a power detection unit outputs an enable signal when remaining power of the battery is lower than a default value and a recovery signal when system power is recovered. A central processing unit backs up user information stored in the RAM to the predetermined region when receiving the enable signal, and stores user information in the predetermined region into the RAM when receiving the recovery signal.

The present invention also provides a method for avoiding data loss in a PDA.

The method of the invention utilizes a PDA including RAM, a battery, a nonvolatile accessible memory, a CPU and a power detection unit, wherein the nonvolatile accessible memory has a predetermined region. User information stored in the RAM is backed up to the predetermined region when remaining power is lower than a default value. Next, user information in the predetermined region is restored to the RAM when system power is recovered.

### BRIEF DESCRIPTION OF THE DRAWINGS

The present invention can be more fully understood by reading the subsequent detailed description and examples with reference made to the accompanying drawings, wherein:

FIG. 1 is a block diagram of a conventional personal digital assistant;

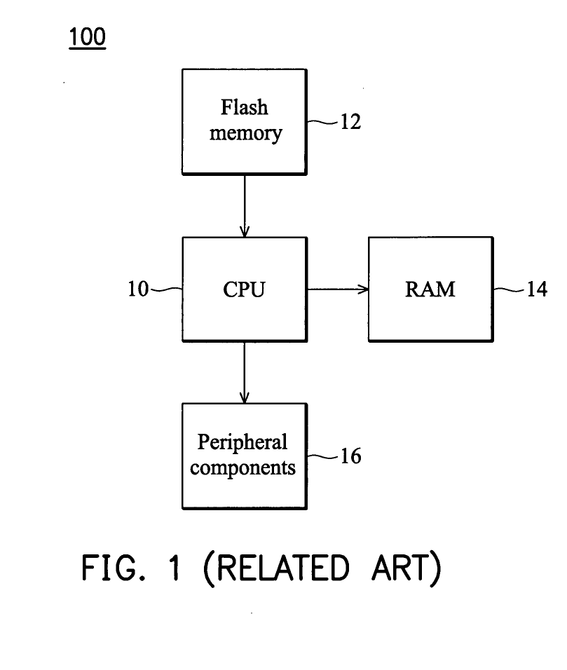

FIG. 2 is a block diagram of the personal digital assistant according to the present invention;

FIG. 3 is a flowchart of the method for avoiding data loss in a PDA according to the present invention;

FIG. 4 is a flowchart illustrating user information being written to the predetermined region according to the present invention; and

FIG. 5 is another flowchart of the method for avoiding data loss in a PDA according to the present invention.

### DETAILED DESCRIPTION OF THE INVENTION

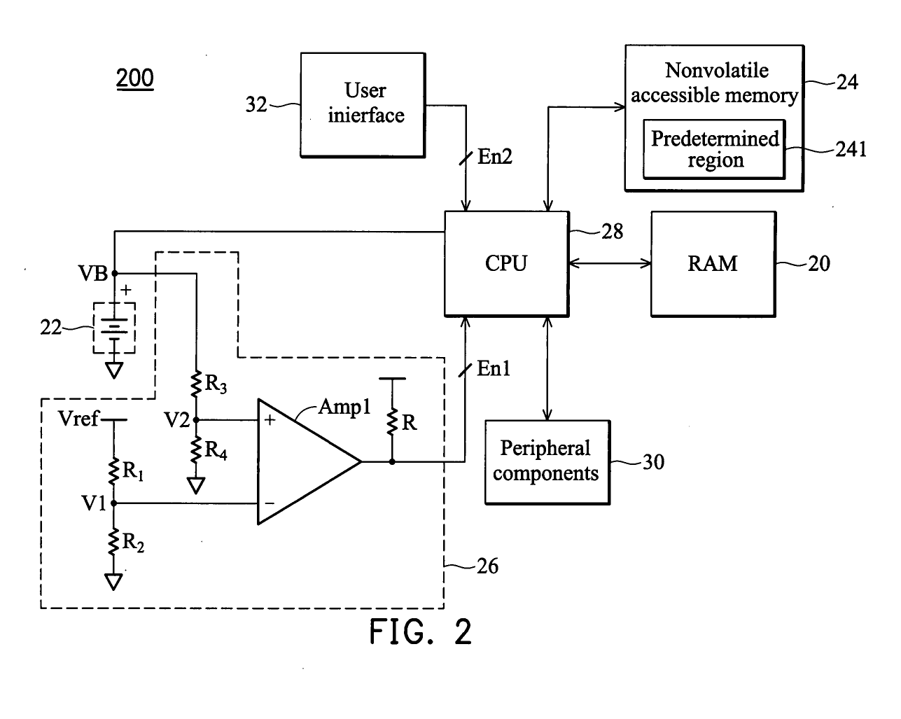

FIG. 2 shows a personal digital assistant (PDA) 200 according to the present invention. The PDA 200 includes a random access memory (RAM) 20, a battery 22, a nonvolatile accessible memory 24, a power detection unit 26 and a central processing unit (CPU) 28.

The RAM 20 stores user information, such as file system, registry, global operating system settings and the like. In the present invention, the RAM 20 is a SDRAM with high access speed, and the battery 22 powers the PDA 200.

The nonvolatile accessible memory 24 is a memory capable of completely retaining stored data after being powered off. For example, the nonvolatile accessible memory 24 can be a magnetic random access memory, a flash memory or the like. In the present invention, the nonvolatile accessible memory 24 is a flash memory with a predetermined region 241. For example, the predetermined region 241 can have a storage capacity of 16 megabytes, and the predetermined region 241 backs up user information. In addition, the nonvolatile accessible memory 24 stores a recovery program, preset data, and programs, wherein the recovery program is executed to restore user information to the RAM 20.

The power detection unit 26 detects whether the voltage VB (remaining power) of the battery 22 is lower than a default value, and informs central processing unit 28 of the detected result. For example, the power detection unit 26 can be a comparison circuit including an amplifier Amp1, resistors R1-R4 and R. The power detection unit 26 outputs a first enable signal EN1 to the CPU 28 when detecting that remaining power (voltage) of the battery 22 is lower than the default value and outputs a recovery signal to the CPU 28 when system power is recovered. Namely, the power detection unit 26 outputs the first enable signal EN1 to the CPU 28 when the voltage V2 across the resistor R4 is lower than the voltage V2 across the resistor R2.

The central processing unit (CPU) 28, can be, for example, a microprocessor, a microcontroller and the like. The CPU 28 writes user information from the RAM 20 to the predetermined region 241 of the nonvolatile accessible memory 24 in response to the enable EN1. The CPU 28 further executes the recovery program stored in the nonvolatile accessible memory 24 to restore user information from the predetermined region 241 to the RAM 20 in response to the recovery signal.

The present invention can not only back up user information automatically as mentioned above but also manually. The PDA 200 of the present invention further includes a user interface 32, such that a second enable signal EN2 is output to the CPU 28 manually through the user interface. Thus, the CPU 28 backs up user information stored in the RAM 20 to the predetermined region 241 of the nonvolatile accessible memory 24. In the present invention, the PDA 200 further includes an LCD display, a keypad, an infrared transducer, and the like as the peripheral component 30. In addition, the PDA 200 of the present invention can also include an external nonvolatile accessible memory with a predetermined region dedicated for backing up user information.

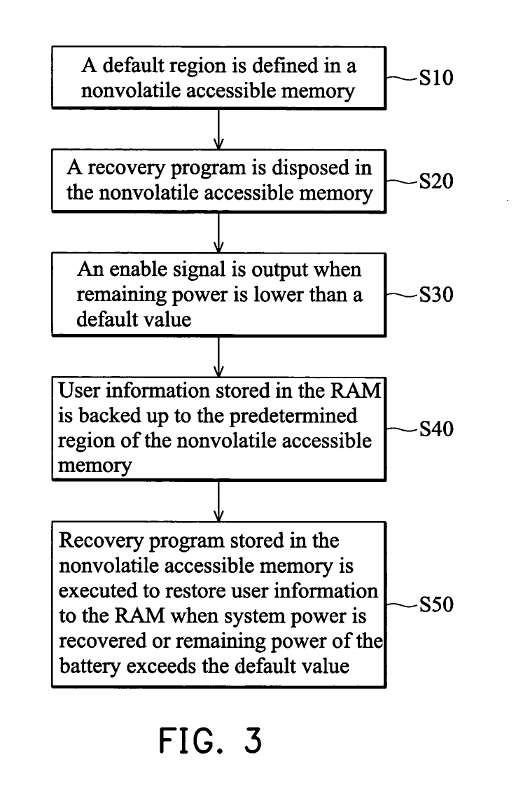

FIG. 3 illustrates the method for avoiding data loss in a PDA according to the present invention. First, in step 10, a predetermined region 241 is defined in a nonvolatile accessible memory 24. For example, the predetermined region 241 can have a storage capacity of 16 megabytes, although it is to be understood that the invention is not limited to the embodiments disclosed.

Next, in step S20, a recovery program is disposed in the nonvolatile accessible memory 24 to restore user information to the RAM 20 from the predetermined region 241.

In step S30, remaining power of the battery 22 in the PDA 200 is detected by a power detection unit 26. The power detection unit 26 outputs an enable signal En1 when remaining power is lower than a default value.

Next, in step S40, user information stored in the RAM 20 is backed up to the predetermined region 241 of the nonvolatile accessible memory 24 by the CPU 28 when the enable signal En1 is received.

Finally, in step S50, the power detection unit 26 outputs a recovery signal to the CPU 28 when system power is recovered or the voltage VB (remaining power) of the battery exceeds the default value. The CPU 28 then executes the recovery program stored in the nonvolatile accessible memory 24 to restore user information to the RAM 20.

Thus, the PDA 200 of the present invention can back up user information to a predetermined region automatically when system power is low or lost.

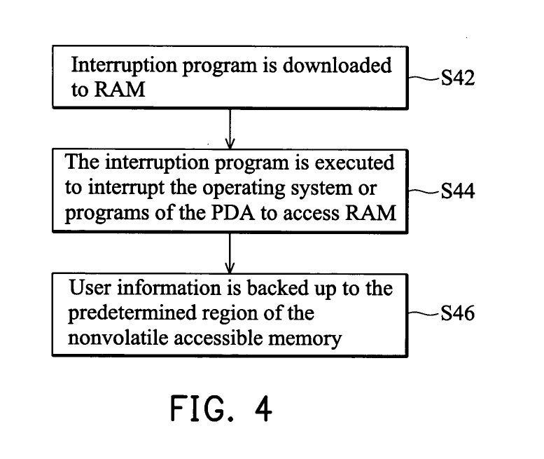

FIG. 4 is a flowchart illustrating user information being written to the predetermined region in response to the present invention. To retain global operating system settings, the CPU 28 executes an interruption program to interrupt the operating system or programs to access RAM 20. Thus, the global operating system settings stored in the RAM 20 are secured. For example, the interruption program can be stored in the nonvolatile accessible memory 24. In step S42, when the CPU receives the enable signal En1, the CPU 28 downloads the interruption program to RAM 20. In step S44, the CPU then executes the interruption program to interrupt the operating system or programs of the PDA 200 to access RAM 20. Next, in step 46, the CPU 28 backs up user information including file system, registry, and global operating system settings to the predetermined region 241 of the nonvolatile accessible memory 24. Thus, the present invention can not only avoid loss of user information but also of global operating system settings.

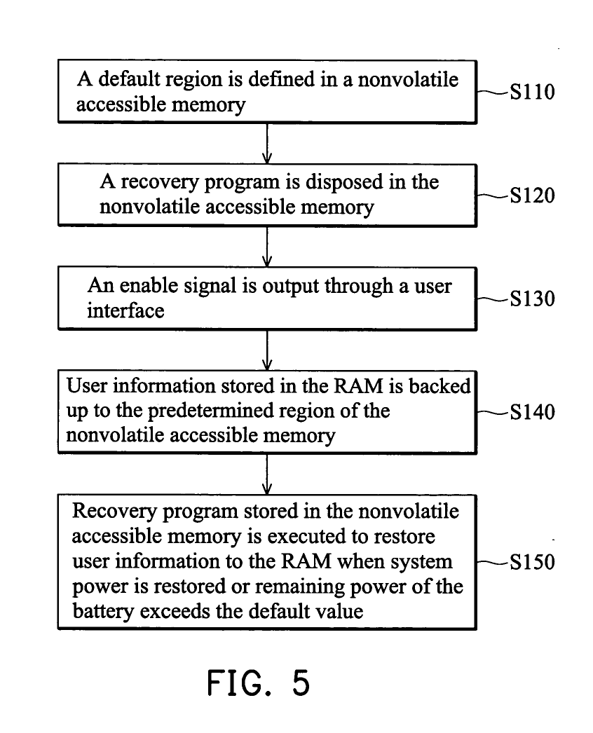

FIG. 5 is another flowchart of the method for avoiding data loss in a PDA according to another embodiment of the present invention.

In this embodiment, a predetermined region 241 is defined in a nonvolatile accessible memory 24 to back up user information, in step S110. For example, the predetermined region 241 may have storage capacity of 16 megabytes, although it is to be understood that the invention is not limited to the embodiments disclosed.

Next, in step S120, a recovery program is disposed in the nonvolatile accessible memory 24 to restore user information to the RAM 20 from the predetermined region 241.

In step S130, a second enable signal En2 is output to the CPU through a user interface.

Next, in step S140, user information stored in the RAM 20 is backed up to the predetermined region 241 of the nonvolatile accessible memory 24 by the CPU 28 when receiving the second enable signal En2.

To retain global operating system settings, the CPU 28 executes an interruption program to interrupt the operating system or programs to access RAM 20. Thus, the global operating system settings stored in the RAM 20 are secured. As shown in FIG. 4, for example, the interruption program is stored in the nonvolatile accessible memory 24. In step S42, when the CPU receives the enable signal En2, the CPU 28 downloads the interruption program to RAM 20. In step S44, the CPU then executes the interruption program to interrupt the operating system or programs of the PDA 200 to access RAM 20. Next, in step 46, the CPU 28 backs up user information including file system, registry, and operating system global settings to the predetermined region 241 of the nonvolatile accessible memory 24.

Finally, in step S150, the power detection unit 26 outputs a recovery signal to the CPU 28 when system power is restored or the voltage VB (remaining power) of the battery exceeds the default value. The CPU 28 then executes the recovery program stored in the nonvolatile accessible memory 24 to restore user information to the RAM 20.

Thus, the PDA 200 of the present invention can back up user information to a predetermined region of a flash memory through a user interface when system power is low or lost. When system power is recovered, user information, such as file system, registry, and global operating system settings, can be written back to the RAM. The PDA can thus recover the original settings and information.

While the invention has been described by way of example and in terms of the preferred embodiments, it is to be understood that the invention is not limited to the embodiments disclosed. To the contrary, it is intended to cover various modifications and similar arrangements (as would be apparent to those skilled in the art). Therefore, the scope of the appended claims should be accorded the broadest interpretation so as to encompass all such modifications and similar arrangements.

what is claimed is:

1. A method for avoiding data loss in a PDA, wherein the PDA has a RAM to store user information, a battery to power the PDA, a CPU, and a nonvolatile accessible memory with a predetermined region, the method comprising:
backing up user information stored in the RAM into the predetermined region when remaining power of the battery is lower than a default value; and
restoring user information from the predetermined region to the RAM when system power is recovered.

2. The method as claimed in claim 1, wherein the PDA further comprises a power detection unit to output an enable signal when remaining power of the battery is detected as lower than the default value, and output a recovery signal when remaining power of the battery exceeds the default value, wherein the CPU backs up user information stored in the RAM to the predetermined region in response to the enable signal, and restores user information from the predetermined region to the RAM in response to the recovery signal.

3. The method device as claimed in claim 1, further comprising a step of interrupting access to the RAM before backing up user information into the predetermined region.

4. The method as claimed in claim 1, wherein user information comprises file system, registry, and global operating system settings.

5. A method for avoiding data loss in a PDA, wherein the PDA has a RAM to store user information, a battery to power the PDA, a CPU, a nonvolatile accessible memory to store preset data, and a user interface to output an enable signal and a recovery signal, wherein the nonvolatile accessible memory has a predetermined region, the method comprising:
backing up user information stored in the RAM into the predetermined region in response to the enable signal; and
restoring user information from the predetermined region to the RAM in response to the recovery signal.

6. The method as claimed in claim 5, further comprising a step of interrupting access to the RAM before backing up user information into the predetermined region.

7. The method as claimed in claim 6, wherein user information comprises file system, registry, and global operating system settings.

8. A PDA capable of avoiding data loss, comprising:
a nonvolatile accessible memory having a predetermined region;
a RAM to store user information;
a battery to power the PDA; and
a power detection unit to output an enable signal when remaining power of the battery is detected as lower than the default value, and to output a recovery signal when remaining power of the battery exceeds the default value.

9. The PDA as claimed in claim 8, wherein the CPU interrupts access to the RAM before backing up user information into the predetermined region.

10. The PDA as claimed in claim 8, wherein the predetermined region backs up user information only.

11. The PDA as claimed in claim 8, further comprising a user interface to output the enable single and the recovery signal.

12. The PDA as claimed in claim 8, wherein the nonvolatile accessible memory further stores preset data.

13. The PDA as claimed in claim 8, wherein the nonvolatile accessible memory is flash memory.

14. The PDA as claimed in claim 8, wherein the RAM is SDRAM.

15. The PDA as claimed in claim 5, wherein the power detection unit comprises:
an amplifier having an output terminal coupled to the CPU;
a first resistor coupled between a positive end of the battery and a non-inversion input terminal of the amplifier;
a second resistor coupled between a negative end of the battery and ground;
a third resistor coupled between a reference voltage and an inversion input terminal of the amplifier;
a fourth resistor coupled between the non-inversion input terminal of the amplifier and the ground; and
a fifth resistor coupled to the output terminal of the amplifier.

16. A PDA capable of avoiding data loss, comprising:
a nonvolatile accessible memory storing preset data and programs;
a RAM to store user information;
an external flash memory having a predetermined region;
a battery to power the PDA;
a power detection unit to output an enable signal when remaining power of the battery is detected as lower than a default value, and output a recovery signal when remaining power of the battery exceeds the default value; and
a CPU coupled to the nonvolatile accessible memory, the RAM and the external flash memory, to back up user data stored in the RAM to the predetermined region when receiving the enable signal and to restore user information to the RAM when receiving the recovery signal.

17. The PDA as claimed in claim 16, wherein the CPU interrupts access to RAM before backing up user information into the predetermined region.

18. The PDA as claimed in claim 16, wherein the predetermined region of the external flash memory backs up user information only.

19. The PDA as claimed in claim 16, further comprising a user interface to output the enable signal and the recovery signal.

20. The PDA as claimed in claim 16, wherein the RAM is synchronous DRAM (SDRAM).

21. A method for avoiding data loss in a PDA, wherein the PDA has a RAM to store user information, a battery to power the PDA, and a nonvolatile accessible memory to store preset data, and the nonvolatile accessible memory has a predetermined region, the method comprising:
backing up user information stored in the RAM to the predetermined region in response to voltage variation of the battery.
